(19) United States
(12) Patent Application Publication
(10) Pub. No.: US 2026/0118737 A1
(43) Pub. Date: Apr. 30, 2026

(54) FLASH DEVICE

(71) Applicant: GUANGZHOU LUXVISIONS INNOVATION TECHNOLOGY LIMITED, Guangzhou City (CN)

(72) Inventors: Guan-Yang Liu, Guangzhou City (CN); Yi-Wei Liu, Guangzhou City (CN)

(73) Assignee: GUANGZHOU LUXVISIONS INNOVATION TECHNOLOGY LIMITED, Guangzhou City (CN)

(21) Appl. No.: 19/228,810

(22) Filed: Jun. 5, 2025

(30) Foreign Application Priority Data
Oct. 24, 2024 (CN) 202411493712.1

(51) Int. Cl. G03B 15/03

(52) U.S. Cl. CPC G03B 15/03; G03B 2215/0567; G03B 2215/0592

(57) ABSTRACT

A flash device including a light-emitting diode array and an optical lens group is provided. The light-emitting diode array includes a plurality of light-emitting diode pixels arranged in an array and independently operable and controllable, wherein the light-emitting diode pixels include a plurality of light-emitting diode pixels of a plurality of different light-emitting colors. The optical lens group includes a plurality of optical lenses, configured to collect, converge, and diverge a light beam from the light-emitting diode array.

### CROSS-REFERENCE TO RELATED APPLICATION

This application claims the priority benefit of China application serial no. 202411493712.1, filed on Oct. 24, 2024. The entirety of the above-mentioned patent application is hereby incorporated by reference herein and made a part of this specification.

### BACKGROUND

### Technical Field

The disclosure relates to a light source device, and more particularly to a flash device.

### Description of Related Art

With the popularity of smartphones and tablet computers and the pursuit of image quality, it is necessary to use an additional light source to increase the ambient brightness in low-illuminance scenes so that an image capturing device can acquire sufficient imaging information. In this regard, a flash module is an indispensable device as it can adjust a light-emitting angle, improve light-emitting efficiency, and enhance uniformity through a flash lens group with appropriate optical design.

Currently, single-color-temperature flashes configured in mobile devices mostly use yellow phosphor coated on a blue light-emitting diode (LED). After the blue light excites the yellow phosphor, white light is generated to produce a range supplementary lighting effect. However, the use of such a light source has the following disadvantages: (1) an excitation spectrum lacks green and red wavelength bands, resulting in poor color rendering; (2) image colors are distorted with a cold tone bias; (3) color temperature cannot be changed according to a scene; and (4) a fixed supplementary lighting range cannot change a light beam shape according to a focal length of a used lens or a target object. Therefore, in the pursuit of improving image quality of mobile devices, the advancement of flash modules is an inevitable challenge to be addressed.

### SUMMARY

The disclosure relates to a flash device. The illumination provided thereby achieves advantages of improved color rendering, adjustable color temperature, and adjustable supplementary lighting coverage.

An embodiment of the disclosure provides a flash device, including a light-emitting diode array and an optical lens group. The light-emitting diode array includes a plurality of light-emitting diode pixels arranged in an array and independently operable and controllable. The plurality of light-emitting diode pixels include a plurality of light-emitting diode pixels of a plurality of different light-emitting colors. The optical lens group includes a plurality of optical lenses, configured to collect, converge, and diverge a light beam from the light-emitting diode array.

In the flash device of the embodiment of the disclosure, a plurality of light-emitting diode pixels arranged in an array and independently operable and controllable are adopted, and the plurality of light-emitting diode pixels include a plurality of light-emitting diode pixels of a plurality of different light-emitting colors. Therefore, by independently controlling whether the plurality of light-emitting diode pixels emit light or not, or by independently controlling a light-emitting intensity ratio of different light-emitting diode pixels, the illumination provided by the flash device of the embodiment of the disclosure can achieve advantages of improved color rendering, adjustable color temperature, and adjustable supplementary lighting coverage.

### BRIEF DESCRIPTION OF THE DRAWINGS

FIG. 1 is a schematic diagram of a light path of a flash device according to an embodiment of the disclosure.

FIG. 2 is a cross-sectional schematic diagram of the flash device of FIG. 1.

FIGS. 3A to 3D are schematic diagrams of arrangements of light-emitting diode pixels of different color temperatures of a light-emitting diode array.

FIG. 4 is a curve graph showing a modulation transfer function of an illuminated target surface in FIG. 1 imaging through an optical lens group onto a light-emitting diode array.

FIG. 5 is a curve graph showing axial chromatic aberration of the illuminated target surface in FIG. 1 imaging through the optical lens group onto the light-emitting diode array.

FIG. 6 is a curve graph showing, when all the light-emitting diode pixels in the light-emitting diode array in FIG. 1 are turned on and are all set to the same light-emitting intensity, illuminance uniformity of the illuminated target surface at a distance of one meter from the flash device with respect to a half field of view.

FIG. 7 is a curve graph showing an illuminance gain value (of the flash device in FIG. 1 with respect to a light-emitting diode array without the optical lens group) with respect to the half field of view.

FIG. 8 is a flowchart of an operation of the flash device in FIG. 1 when applied to a camera.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

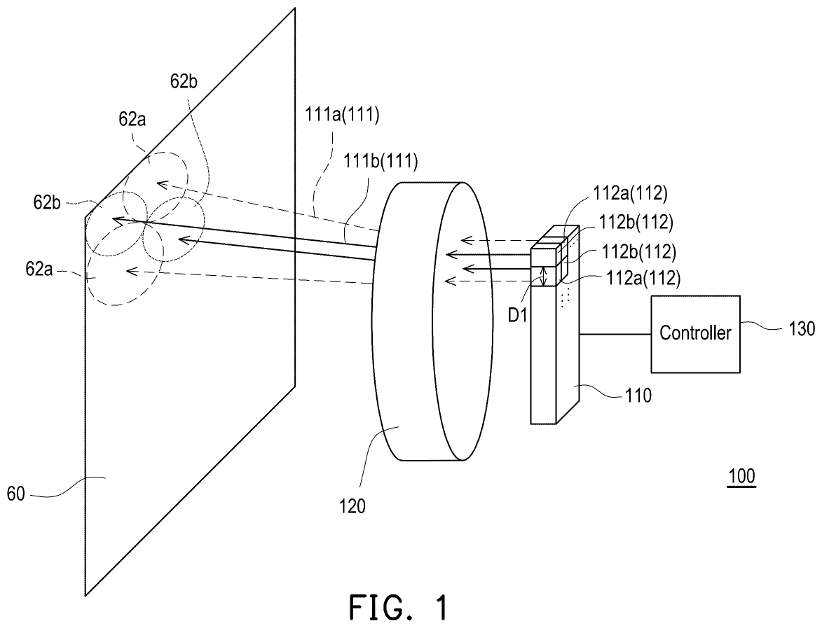

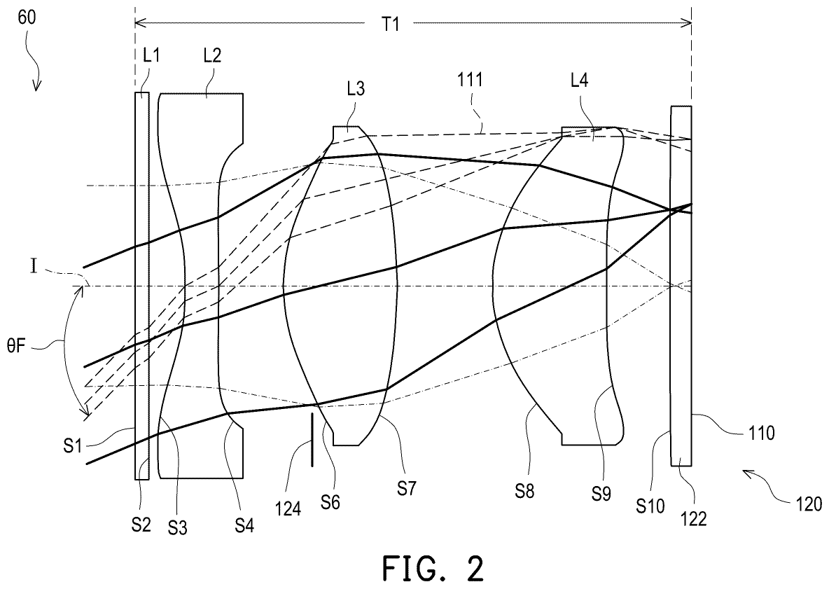

FIG. 1 is a schematic diagram of a light path of a flash device according to an embodiment of the disclosure, and FIG. 2 is a cross-sectional schematic diagram of the flash device of FIG. 1. Referring to FIG. 1 and FIG. 2, a flash device 100 of this embodiment includes a light-emitting diode array 110 and an optical lens group 120. The light-emitting diode array 110 includes a plurality of light-emitting diode pixels 112 arranged in an array and independently operable and controllable, wherein the light-emitting diode pixels 112 include light-emitting diode pixels of a plurality of different light-emitting colors (in FIG. 1, for example, the light-emitting diode pixels of a plurality of different light-emitting colors include two kinds of different light-emitting colors of light-emitting diode pixels 112a and light-emitting diode pixels 112b). The optical lens group 120 includes a plurality of optical lenses (in FIG. 1, for example, including optical lenses L1, L2, L3, and L4), configured to collect, converge, and diverge a light beam 111 from the light-emitting diode array 110.

In the flash device 100 of this embodiment, a plurality of light-emitting diode pixels 112 arranged in an array and independently operable and controllable are adopted, and the light-emitting diode pixels 112 include light-emitting diode pixels 112a and 112b of a plurality of different light-emitting colors. Therefore, by independently controlling light emission or non-light emission of different light-emitting diode pixels 112, or by independently controlling a light-emitting intensity ratio of different light-emitting diode pixels 112, the illumination provided by the flash device 100 of this embodiment can achieve advantages of improved color rendering, adjustable color temperature, and adjustable supplementary lighting coverage.

Specifically, in this embodiment, the light-emitting diode pixels 112 include light-emitting diode pixels 112a and 112b of a plurality of different color temperatures that are arranged in a staggered manner. In this embodiment, the flash device 100 further includes a controller 130 electrically connected to the light-emitting diode array 110 and configured to control a light-emitting intensity ratio and a light-emitting region of the light-emitting diode pixels 112a and 112b of the plurality of different color temperatures by controlling a current that drives the light-emitting diode pixels 112. For example, a color temperature of a light beam 111a emitted from the light-emitting diode pixel 112a is higher than a color temperature of a light beam 111b emitted from the light-emitting diode pixel 112b. Therefore, by controlling a strength ratio of the light beams 111a and 111b emitted from the light-emitting diode pixels 112a and 112b, or controlling one of the light-emitting diode pixels 112a and 112b to emit light and the other to not emit light, a plurality of light beams 111 of different color temperatures can be formed. That is, in this embodiment, the light-emitting diode pixel 112a is a high color temperature white light-emitting diode, and the light-emitting diode pixel 112b is a low color temperature white light-emitting diode. However, in other embodiments, the light-emitting diode pixels 112 may also be light-emitting diodes of other colors, for example, including red light, green light, and blue light-emitting diodes. In addition, for example, if light-emitting diode pixels 112 of a partial region of the light-emitting diode array 110 are controlled to emit light, and light-emitting diode pixels 112 of other regions do not emit light, or light-emitting diode pixels 112 of the entire light-emitting diode array 110 are controlled to emit light, a light-emitting region of the light-emitting diode array 110 can be controlled and adjusted, and further, a lighting coverage of the flash device 100 can be controlled and adjusted. In an embodiment, the controller 130 is configured to determine a light-emitting region of the light-emitting diode array 110 according to a focal length of a photographing lens of a camera equipped with the flash device 100 or a shape of a target object, and further to determine a lighting coverage of the flash device 100. In an embodiment, the light-emitting diode pixels 112 are, for example, micro light-emitting diodes. However, the disclosure is not limited thereto. In other embodiments, the light-emitting diode pixels 112 may also be light-emitting diodes of other sizes.

In this embodiment, the controller 130, in response to the flash device 100 being in a low light source environment, adjusts a color temperature of a light beam 111 emitted from the light-emitting diode array 110 according to an ambient color temperature, an object color, a portrait skin tone brightness, or a required special effect.

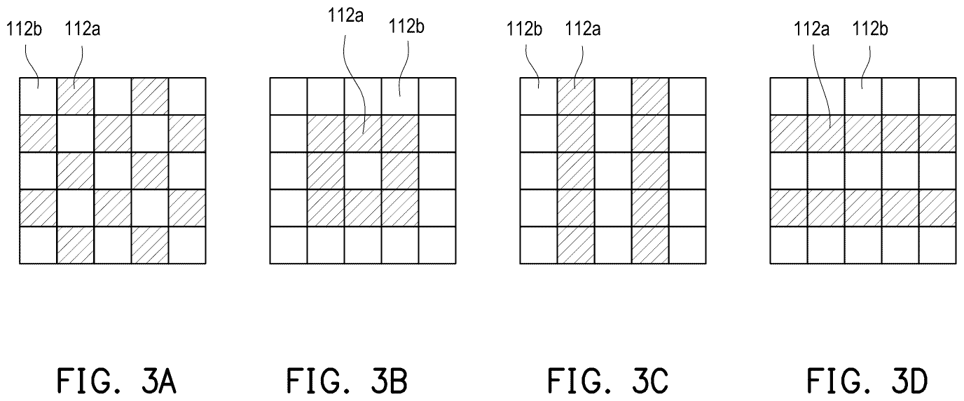

FIGS. 3A to 3D are schematic diagrams of arrangements of light-emitting diode pixels of different color temperatures of the light-emitting diode array. Referring to FIG. 1, FIG. 2, and FIGS. 3A to 3D, a staggered arrangement of the light-emitting diode pixels 112a and 112b of the plurality of different color temperatures of the light-emitting diode array 110 is, for example, a chessboard-format staggered arrangement (as shown in FIG. 3A), an annular staggered arrangement (as shown in FIG. 3B), a column-staggered arrangement (as shown in FIG. 3C), or a row-staggered arrangement (as shown in FIG. 3D), but the disclosure is not limited thereto.

In this embodiment, the optical lens group 120 includes a first lens L1, a second lens L2, a third lens L3, and a fourth lens L4 that are sequentially arranged from an illuminated target surface 60 toward the light-emitting diode array 110 along an optical axis I. In this embodiment, the optical lens group 120 further includes a protective glass 122 disposed between the fourth lens L4 and the light-emitting diode array 110. In this embodiment, the optical lens group 120 further includes an aperture stop 124 located between the second lens L2 and the third lens L3. In this embodiment, a total thickness T1 of the optical lens group 120 is, for example, less than 8.5 millimeters, wherein the total thickness T1 is a distance on the optical axis I from a target-side surface S1 of the first lens L1 to a light-emitting surface of the light-emitting diode array 110, wherein the target-side surface S1 is a surface of the first lens L1 that faces away from the light-emitting diode array 110, that is, a surface of the first lens L1 that faces the illuminated target surface 60. In an embodiment, the total thickness T1 is, for example, 8.44 millimeters. In addition, in this embodiment, an f-number of the optical lens group 120 is less than 0.98.

In this embodiment, the first lens L1 is a Fresnel lens having a concentric annular serrated surface (for example, a concentric annular serrated surface surrounding the optical axis I) and having a positive focal power, that is, having a positive refractive power. In this embodiment, refractive powers of the second lens L2, the third lens L3, and the fourth lens L4 are sequentially negative, positive, and positive. In addition, in this embodiment, the second lens L2 is a biconcave lens, the third lens L3 is a biconvex lens, and the fourth lens L4 is a meniscus lens having a convex surface facing the illuminated target surface 60.

In this embodiment, two opposite surfaces of each of the second lens L2, the third lens L3, and the fourth lens L4 are aspherical, and the two opposite surfaces respectively face the illuminated target surface 60 and the light-emitting diode array 110. In addition, in this embodiment, a greatest diameter of the first lens L1, the second lens L2, the third lens L3, and the fourth lens LA does not exceed 6.52 millimeters.

In this embodiment, a target-side surface S1 of the first lens L1 is a Fresnel surface, and a light-source-side surface S2 of the first lens L1 is a flat surface, wherein the light-source-side surface S2 refers to a surface of the first lens L1 that faces the light-emitting diode array 110, that is, a surface of the first lens L1 that faces away from the illuminated target surface 60. Since the flash device 100 on a portable electronic device has a limitation in thickness, characteristics of a Fresnel lens for thinning an optical element are used to make full use of limited space. The serrated Fresnel lens can prevent a user from seeing an internal component structure from the outside, increase aesthetics, and be mass-produced by plastic injection molding. A target-side surface S3 and a light-source-side surface S4 of the second lens are both concave surfaces. A target-side surface S6 and a light-source-side surface S7 of the third lens L3 are both convex surfaces. The third lens L3 is mainly configured to change a deflection angle of a light path. A target-side surface S8 of the fourth lens LA is a convex surface, and a light-source-side surface S9 of the fourth lens LA is a concave surface. The fourth lens LA is mainly configured to shape a light beam 111 emitted from the micro light-emitting diode array 110.

Radii of curvature, thicknesses (a thickness value in the row where the target-side surface S1 is included is a center thickness of the lens L1 on the optical axis I, and a value in the row where the light-source-side surface S2 is included is an air interval between the lens L1 and the lens L2 on the optical axis I, and so on), refractive indices of materials used in the respective lenses, and Abbe numbers of the optical elements of the light-emitting diode array 110 are shown in Table 1.

TABLE 1

| | | | Radius | | | |
|---|---|---|---|---|---|---|
| | | | of | | | |
| | Surface | | curvature | Thickness | Refractive | Abbe |
| Lens | number | Type | (mm) | (mm) | index | number |
| Illuminated | S0 | Spherical | ∞ | 1000 | — | — |
| target | | | | | | |
| surface 60 | | | | | | |
| L1 | S1 | Fresnel | 15.000 | 0.200 | 1.492 | 57.441 |
| | S2 | Spherical | ∞ | 0.500 | | |
| L2 | S3 | Aspherical | −3.229 | 0.450 | 1.536 | 55.981 |
| | S4 | Aspherical | −40.490 | 1.314 | | |
| Aperture stop 124 | | Spherical | ∞ | −0.400 | — | — |
| L3 | S6 | Aspherical | 2.304 | 1.590 | 1.536 | 55.981 |
| | S7 | Aspherical | −7.787 | 1.317 | | |
| L4 | S8 | Aspherical | 1.324 | 1.580 | 1.536 | 55.981 |
| | S9 | Aspherical | 112.252 | 0.890 | | |
| Protective | S10 | Spherical | ∞ | 0.300 | 1.517 | 64.167 |
| glass 122 | | | | | | |

Except that a surface S10 of the protective glass 122 is a flat surface and a surface S0 of the illuminated target surface 60 is, for example, a flat surface, other surfaces including a target-side surface S3 and a light-source-side surface S4 of the second lens L2, a target-side surface S6 and a light-source-side surface S7 of the third lens L3, and a target-side surface S8 and a light-source-side surface S9 of the fourth lens LA are all of aspherical design. Each aspherical surface shape can be described by the following Formula (1):

$$z = \frac{{cr}^{2}}{1 + \sqrt{1 - ( 1 + k ) {c}^{2} {r}^{2}}} + {\sum }_{i = 1}^{N} {α}_{i} {r}^{2 i} \qquad Formula ( 1 )$$

Wherein Formula (1) is an even-order aspherical formula, c is a curvature near the optical axis of the aspherical surface, k is a conic constant, r is a radial coordinate, α₁ is a 2i-th order aspherical coefficient (for example, α₂ is a 4th-order aspherical coefficient, α₃ is a 6th-order aspherical coefficient, and so on), and z represents a distance in the optical axis direction from the vertex of the aspherical surface to a coordinate point at a position with a height radius r from the central optical axis. Related conic constants and aspherical coefficients of the aspherical lenses are shown in Table 2.

TABLE 2

| | S3 | S4 | S6 | S7 | S8 | S9 |
|---|---|---|---|---|---|---|
| k | 0.000 | 0.000 | −0.499 | −586.307 | −34.161 | 2575.171 |
| α₂ | 1.62E−02 | 0.482 | −0.288 | −5.41E−02 | 3.280 | 1.78E−02 |
| α₃ | 1.68E−03 | 0.973 | −1.388 | 2.93E−02 | 9.331 | 4.99E−03 |
| α₄ | 4.18E−06 | 8.331 | 3.994 | −1.15E−02 | 15.748 | −1.53E−03 |
| α₅ | −6.30E−05 | 38.916 | −3.433 | 2.42E−03 | −12.006 | 1.53E−04 |
| α₆ | 8.20E−06 | −20.786 | −3.603 | −2.12E−04 | −2.170 | −3.00E−05 |
| α₇ | −3.08E−07 | 21.135 | 7.924 | 2.03E−06 | 9.316 | |
| α₈ | | −491.408 | −1.104 | −3.15E−08 | −4.154 | |
| α₉ | | 1065.334 | −5.270 | | −0.072 | |
| α₁₀ | | −523.559 | 2.703 | | 0.025 | |

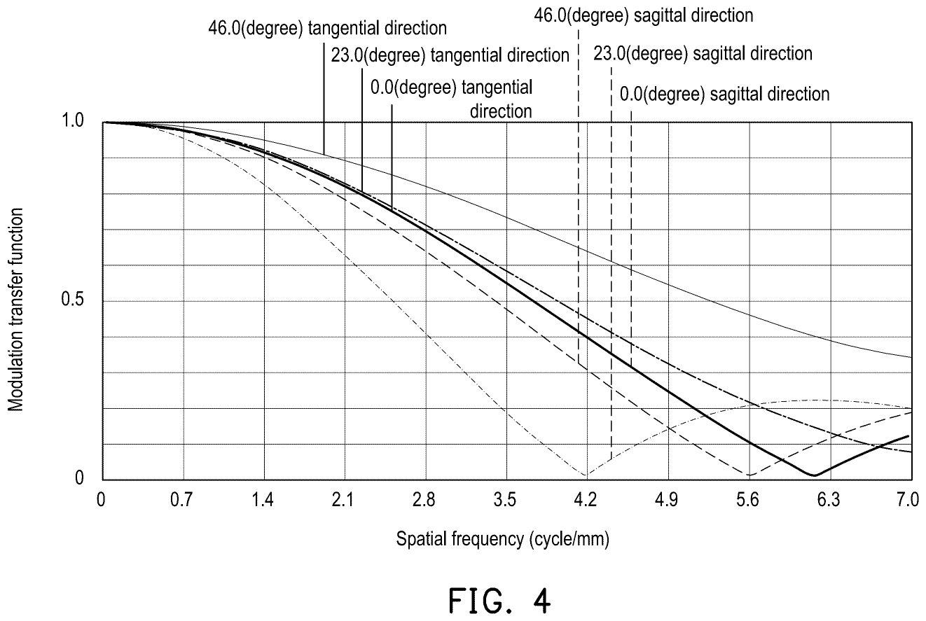

FIG. 4 is a curve graph showing a modulation transfer function of an illuminated target surface in FIG. 1 imaging through an optical lens group onto a light-emitting diode array, wherein 46.0 degrees, 23.0 degrees, and 0.0 degrees represent curves at these field-of-view angles, and a tangential direction and a sagittal direction represent curves corresponding to light in these two directions. Referring to FIG. 1, FIG. 2, and FIG. 4, in this embodiment, a field of view of the optical lens group 120 is greater than 90 degrees, wherein the field of view is, for example, twice a half field of view θF in FIG. 2. An average modulation transfer function of the optical lens group in the tangential direction and the sagittal direction is less than 0.3 at a cutoff frequency, as shown in FIG. 4, wherein the cutoff frequency is an inverse of twice a side length D1 of a light-emitting surface of any one of the light-emitting diode pixels 112 (as shown in FIG. 1). In an embodiment, the side length D1 is less than 75 micrometers. A modulation transfer function less than 0.3 indicates that an image is blurred. Since light is reversible, when an image of the illuminated target surface 60 formed on the light-emitting diode array 110 through the optical lens group 120 is blurred, an image of the light-emitting diode array 110 formed on the illuminated target surface 60 through the optical lens group 120 is also blurred. Therefore, illumination regions 62a and 62b respectively formed on the illuminated target surface 60 by the light-emitting diode pixels 112a and 112b are also blurred and at least partially overlap with each other, which causes a high color temperature illumination region 62a and a low color temperature illumination region 62b to be mixed with each other into an illumination of a desired color temperature.

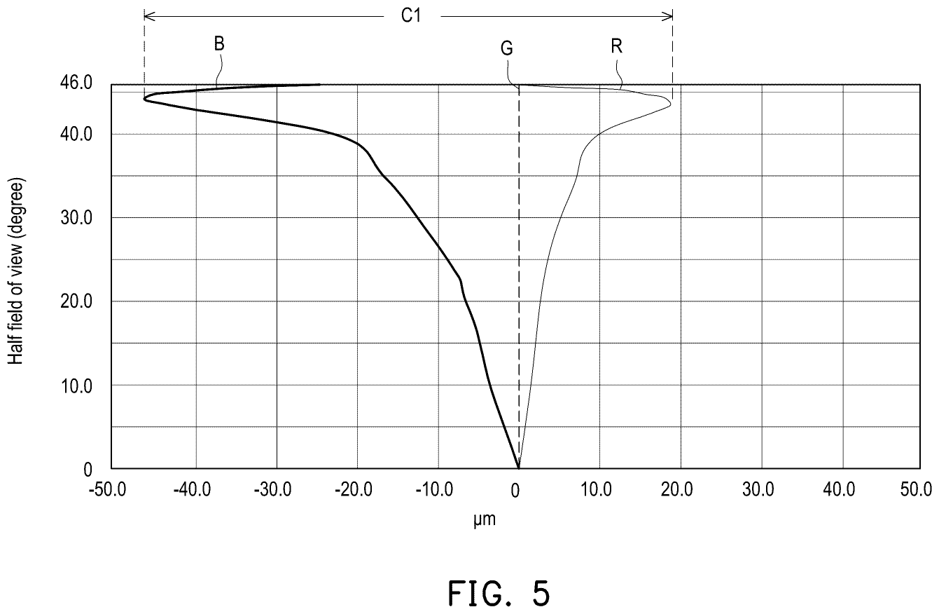

FIG. 5 is a curve graph showing axial chromatic aberration of the illuminated target surface in FIG. 1 imaging through the optical lens group onto the light-emitting diode array, wherein a curve labeled R is an axial chromatic aberration of red light (with a wavelength of 656.27 nanometers), a straight line labeled G is an axial chromatic aberration of green light (with a wavelength of 587.56 nanometers), and a curve labeled B is an axial chromatic aberration of blue light (with a wavelength of 486.13 nanometers). As shown in FIG. 5, an axial chromatic aberration C1 of the optical lens group 120 on the light-emitting diode array 110 is less than the side length D1 of a light-emitting surface of any one of the light-emitting diode pixels 112 (as shown in FIG. 1).

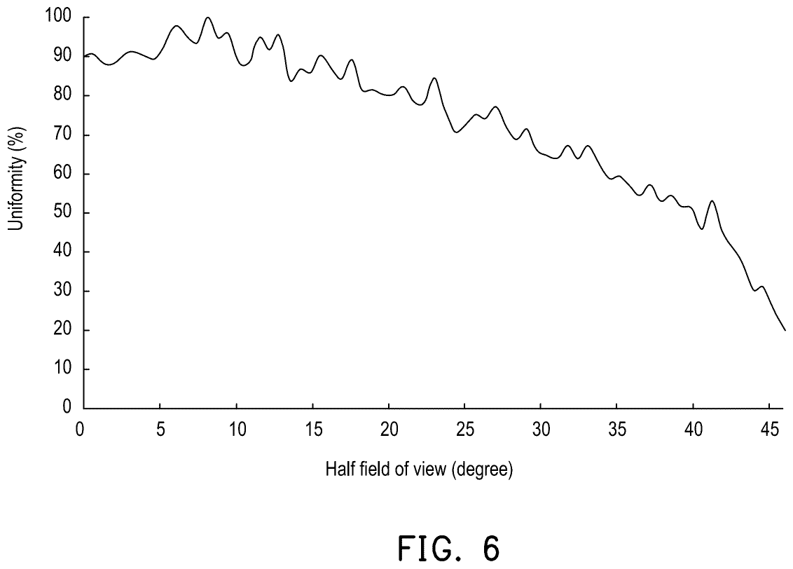

FIG. 6 is a curve graph showing, when all the light-emitting diode pixels in the light-emitting diode array in FIG. 1 are turned on and are all set to the same light-emitting intensity, illuminance uniformity of the illuminated target surface at a distance of one meter from the flash device with respect to a half field of view. Referring to FIG. 1 and FIG. 6, the illuminance uniformity can be defined as area illuminance/maximum illuminance×100%. The flash device 100 of this embodiment can project a light beam with a diagonal direction exceeding 90 degrees, and 20% of the maximum illuminance can still be maintained at the maximum viewing angle. In this embodiment, current intensity of the light-emitting diode pixels 112 increases from a center of the light-emitting diode array 110 toward a periphery, so as to compensate for a difference in light intensity uniformity caused by the optical lens group 120.

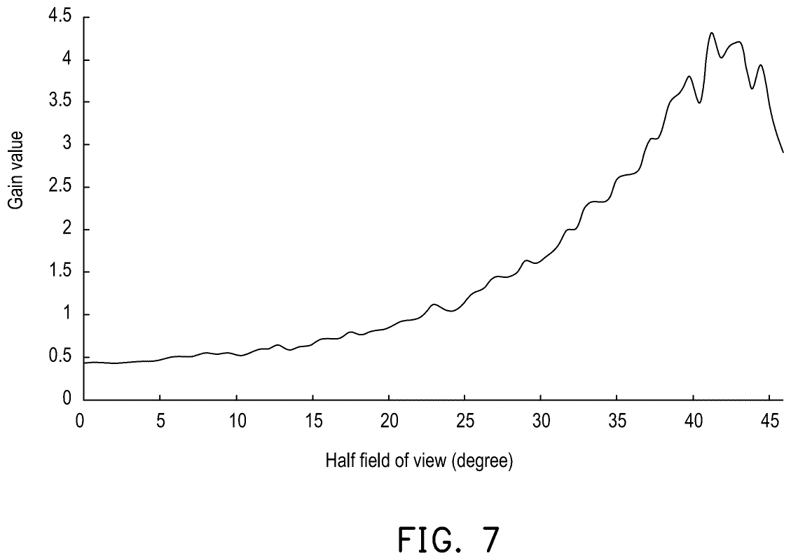

FIG. 7 is a curve graph showing an illuminance gain value (of the flash device in FIG. 1 with respect to a light-emitting diode array without the optical lens group) with respect to the half field of view, wherein in FIG. 7, all light-emitting diode pixels in the light-emitting diode array are turned on and are all set to the same light-emitting intensity, and illuminance refers to an illuminance on an illuminated target surface at a distance of one meter from the flash device (or the light-emitting diode array). Referring to FIG. 1 and FIG. 7, an illumination gain value of an illumination light beam 111 projected by the flash device 100 is greater than an illumination gain value of a light beam 111 emitted from the light-emitting diode array 110 without passing through the optical lens group 120, wherein the gain value can be defined as illuminance of a device under test/illuminance of the light-emitting diode array without the optical lens group. As shown in FIG. 7, after using the designed optical lens group 120, center light energy can be expanded to a larger viewing angle, such that an illuminance gain value of the flash device at a large viewing angle is greater than an illuminance gain value when the optical lens group 120 is not used.

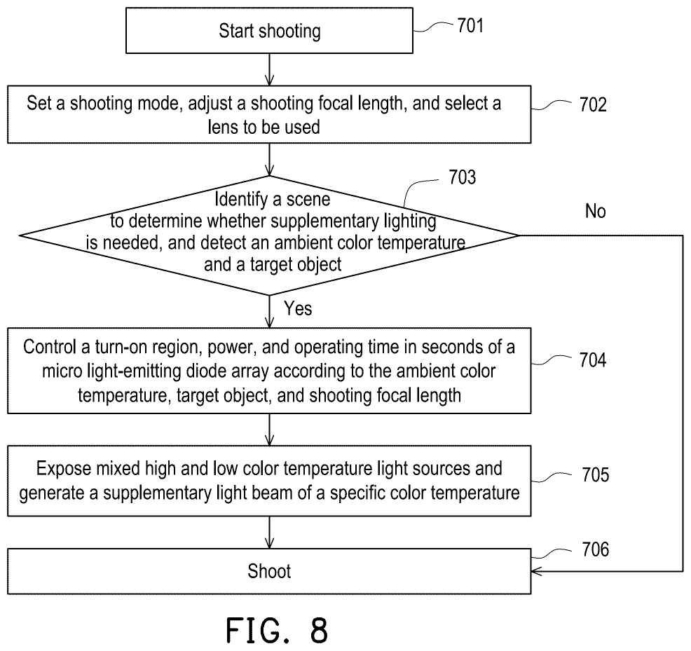

FIG. 8 is a flowchart of an operation of the flash device in FIG. 1 when applied to a camera. Referring to FIG. 1 and FIG. 8, an operation flow of the flash device 100 when applied to a camera may include the following steps. First, step 701 is performed, in which shooting is started. Next, step 702 is performed, in which a shooting mode is set, a shooting focal length is adjusted, and a lens to be used is selected. This step may be performed by the controller 130. Then, step 703 is performed, in which a scene is identified, whether supplementary lighting is needed is determined, and an ambient color temperature and a target object are detected. This may be performed by the controller 130. If it is determined in step 703 that the flash device 100 is not needed for supplementary lighting, step 706 is directly performed, in which shooting is performed, that is, the camera performs an image capturing operation. If it is determined in step 703 that the flash device 100 is needed for supplementary lighting, step 704 is performed, in which a turn-on region, power, and operating time in seconds of the light-emitting diode array are controlled according to the ambient color temperature, the target object, and the shooting focal length. This may be performed by the controller 130. Then, step 705 is performed, in which high and low color temperature light sources (that is, the high color temperature light-emitting diode pixels 112a and the low color temperature light-emitting diode pixels 112b) are mixed and exposed, and a supplementary light beam 111 of a specific color temperature is generated. Then, step 706 is performed, in which the controller 130 commands the camera to perform the image capturing operation.

In an embodiment, when a shooting scene is in an environment with insufficient illuminance and supplementary lighting is required, a light source of a specific region in the light-emitting diode array 110 may be turned on according to a currently selected lens. For example, when a wide-angle lens is used, all light-emitting diode pixels 112 in the light-emitting diode array 110 need to be turned on to meet the requirement of wide-range supplementary lighting. When switching to a telephoto lens, since a field of view range is relatively small, only light-emitting diode pixels 112 in a center region of the light-emitting diode array 110 may be turned on to perform supplementary lighting. In addition, according to system detection of the environment, object color, or portrait skin tone brightness, by adjusting a ratio of high and low color temperature light sources in the light-emitting diode array 110 and through the designed optical lens group, a supplementary light beam 111 with uniformity and an appropriate color temperature conforming to the environment, the object, or the portrait can be generated to meet requirements of various low-light photography.

In summary, in the flash device of the embodiment of the disclosure, a plurality of light-emitting diode pixels arranged in an array and independently operable and controllable are adopted, and the light-emitting diode pixels include light-emitting diode pixels of a plurality of different light-emitting colors. Therefore, by independently controlling light emission or non-light emission of different light-emitting diode pixels, or by independently controlling a light-emitting intensity ratio of different light-emitting diode pixels, the illumination provided by the flash device of the embodiment of the disclosure can achieve advantages of improved color rendering, adjustable color temperature, and adjustable supplementary lighting coverage.

Finally, it should be noted that the above embodiments are only used to illustrate the technical solutions of the disclosure and are not intended to limit the disclosure. Although the disclosure has been described in detail with reference to the foregoing embodiments, those skilled in the art should understand that modifications may still be made to the technical solutions described in the foregoing embodiments, or some or all of the technical features may be replaced with equivalents. These modifications or replacements do not cause the essence of the corresponding technical solutions to deviate from the scope of the technical solutions in the embodiments of the disclosure.

What is claimed is:

1. A flash device, comprising:
a light-emitting diode array, comprising a plurality of light-emitting diode pixels arranged in an array and independently operable and controllable, wherein the plurality of light-emitting diode pixels comprise a plurality of light-emitting diode pixels of a plurality of different light-emitting colors; and
an optical lens group, comprising a plurality of optical lenses configured to collect, converge, and diverge a light beam from the light-emitting diode array.

2. The flash device according to claim 1, wherein the plurality of light-emitting diode pixels comprise a plurality of light-emitting diode pixels of a plurality of different color temperatures that are in a staggered arrangement.

3. The flash device according to claim 2, further comprising a controller, electrically connected to the light-emitting diode array and configured to control a light-emitting intensity ratio and a light-emitting region of the plurality of light-emitting diode pixels of the plurality of the plurality of different color temperatures by controlling a current that drives the plurality of light-emitting diode pixels.

4. The flash device according to claim 2, further comprising a controller, electrically connected to the light-emitting diode array, wherein in response to the flash device being in a low light source environment, the controller adjusts a color temperature of a light beam emitted from the light-emitting diode array according to an ambient color temperature, an object color, a portrait skin tone brightness, or a required special effect.

5. The flash device according to claim 2, wherein the staggered arrangement of the plurality of light-emitting diode pixels of the plurality of different color temperatures is a chessboard-format staggered arrangement, an annular staggered arrangement, a column-staggered arrangement, or a row-staggered arrangement.

6. The flash device according to claim 1, further comprising a controller, electrically connected to the light-emitting diode array, wherein the controller is configured to determine a light-emitting region of the light-emitting diode array according to a focal length of a photographing lens or a shape of a target object.

7. The flash device according to claim 1, wherein a current intensity applied to the plurality of light-emitting diode pixels increases from a center of the light-emitting diode array toward a periphery, so as to compensate for a difference in a light intensity uniformity caused by the optical lens group.

8. The flash device according to claim 1, wherein the optical lens group comprises a first lens, a second lens, a third lens, and a fourth lens sequentially arranged from an illuminated target surface toward the light-emitting diode array along an optical axis, and a total thickness thereof is less than 8.5 millimeters.

9. The flash device according to claim 8, wherein the optical lens group further comprises a protective glass disposed between the fourth lens and the light-emitting diode array.

10. The flash device according to claim 8, wherein the optical lens group further comprises an aperture stop located between the second lens and the third lens.

11. The flash device according to claim 8, wherein an f-number of the optical lens group is less than 0.98.

12. The flash device according to claim 11, wherein a greatest diameter of the first lens, the second lens, the third lens, and the fourth lens does not exceed 6.52 millimeters.

13. The flash device according to claim 8, wherein the first lens is a Fresnel lens having a concentric annular serrated surface and having a positive focal power.

14. The flash device according to claim 8, wherein the second lens is a biconcave lens, the third lens is a biconvex lens, and the fourth lens is a meniscus lens having a convex surface facing the illuminated target surface.

15. The flash device according to claim 8, wherein two opposite surfaces of each of the second lens, the third lens, and the fourth lens are aspherical, and the two opposite surfaces respectively face the illuminated target surface and the light-emitting diode array.

16. The flash device according to claim 8, wherein an axial chromatic aberration of the optical lens group on the light-emitting diode array is less than a side length of a light-emitting surface of any one of the plurality of light-emitting diode pixels.

17. The flash device according to claim 8, wherein a field of view of the optical lens group is greater than 90 degrees, and a modulation transfer function of the optical lens group at a cutoff frequency is less than 0.3.

18. The flash device according to claim 17, wherein the cutoff frequency is an inverse of twice a side length of a light-emitting surface of any one of the plurality of light-emitting diode pixels.

19. The flash device according to claim 8, wherein a plurality of dioptric powers of the second lens, the third lens, and the fourth lens are sequentially negative, positive, and positive.

20. The flash device according to claim 8, wherein an illumination gain value of an illumination light beam projected by the flash device is greater than an illumination gain value of the light beam emitted from the light-emitting diode array without passing through the optical lens group.
